(19) United States
(12) Patent Application Publication
(10) Pub. No.: US 2017/0022039 A1
(43) Pub. Date: Jan. 26, 2017

(54) Pry Bar

(71) Applicant: Rodney Cooper, Clay, NY (US)

(72) Inventor: Rodney Cooper, Clay, NY (US)

(21) Appl. No.: 15/153,855

(22) Filed: May 13, 2016

Related U.S. Application Data
(60) Provisional application No. 62/161,015, filed on May 13, 2015.

(51) Int. Cl. B66F 15/00; B25G 1/10

(52) U.S. Cl. CPC B66F 15/00; B25G 1/10

(57) ABSTRACT

A pry bar tool including a lever shaft; a first end defining a U-shaped or V-shaped engagement portion configured to engage and exert force on a body to be removed from a surface; a curved fulcrum positioned between the elongated lever shaft and the first end; and a forearm handle positioned at a second end, the handle having a curved inner surface sized to receive a forearm and configured to receive a force exerted from said received forearm. The inner surface can include a coating, cushion, or insert to increase comfort and maximize force.

### CROSS-REFERENCE TO RELATED APPLICATION

This application claims priority to U.S. Provisional Patent Application Ser. No. 62/161,015, filed on May 13, 2015 and entitled “Improved Pry Bar,” the entire disclosure of which is incorporated herein by reference.

### FIELD OF THE INVENTION

The present disclosure relates generally to levering devices and more particularly toward an improved pry bar incorporating a strategically placed receptacle for the forearm in order to increase exertion force where leverage is needed.

### BACKGROUND

Pry bars are well-known in the art to pry and pull objects using leverage. The pry bar works as a lever that rotates around the fulcrum, which can rest on the floor, wall, or any other surface near the object that is being pried or pulled out of the surface. The pry bar, which is typically made of steel or some other metal alloy, is straight, bent, or curved to create a fulcrum point. One end of the typical fulcrum has a U- or V-shaped fork structure into which a nail or similar structure to be removed can be wedged. The user operates the pry bar by exerting force on the end opposite the U- or V-shaped fork structure, forcing the pry bar to pivot at the fulcrum and exert an equal force on the nail or similar structure.

Although this method of exerting force using a pry bar has been in use for decades, there are significant drawbacks to the standard pry bar design. For example, to use the pry bar the user grasps the far end of the pry bar and exerts an amount of force required to pry or pull the nail from the surface. It is often the case that a large force is required to pull or pry the nail or similar object. Whether the pry bar is flat or rounded, there is typically only a small surface area for the user to grab onto to exert force. Often a user cannot exert sufficient force on the nail without hurting his or her hands due to the small surface area. Accordingly, there is a long-felt yet unsolved need in the art for a pry bar with a larger surface area that allows the user to exert more force on a nail or similar structure, without causing damage to the user or the surrounding surfaces.

### SUMMARY OF THE INVENTION

The present disclosure is directed to inventive pry bar designs. Embodiments of the inventive pry bar design described or otherwise envisioned herein include a pry bar with a strategically placed receptacle for the forearm in order to increase exertion force where leverage is needed. With the improved pry bar design, the user can exert sufficient force on a nail or similar structure without hurting his or her hands due to the increased surface area and ability to use both the hands and the forearm.

According to an aspect, a prying tool includes: (i) a lever shaft; (ii) a first end defining a U-shaped or V-shaped engagement portion configured to engage and exert force on a body to be removed from a surface; (iii) a curved fulcrum positioned between the elongated lever shaft and the first end; and (iv) a forearm handle positioned at a second end, the handle having a curved inner surface sized to receive a forearm and configured to receive a force exerted from said received forearm.

According to an embodiment, the inner surface of the forearm handle can include a coating, cushion, or insert to increase comfort and maximize force.

According to an embodiment, the lever shaft of the prying tool can have a variety of shapes, configurations, diameters, and thicknesses. The lever shaft can also be coated or textured to maximize grip and force.

According to an embodiment, the forearm handle is sized to receive a forearm of a certain size or range of sizes.

According to an embodiment, the pry bar device is constructed of a steel or steel alloy, such as high-carbon steel.

According to an embodiment, the pry bar device includes a spindle extending outwardly from the device, the spindle configured to allow the pry bar device to be attached or hung to a surface such as a wall, display, or belt.

According to an aspect, a prying tool attachment includes a forearm handle insert having a curved inner surface sized to receive a forearm and configured to receive a force exerted from said received forearm; wherein the prying tool attachment is configured to reversibly or permanently attach to a standard prying tool.

According to an aspect is a pry bar tool comprising: a lever shaft; a first end defining a U-shaped or V-shaped engagement portion configured to engage and exert force on a body to be removed from a surface; a curved fulcrum positioned between the elongated lever shaft and the first end; and a forearm handle positioned at a second end, wherein the handle comprises a curved inner surface sized to receive a forearm and configured to receive a force exerted from said received forearm, and further wherein the forearm handle comprises a first curved arm extending outwardly from the lever shaft and a second curved arm extending outwardly from the lever shaft, wherein a top edge of the first and second arms are substantially perpendicular to the lever shaft, and further wherein a bottom edge of the first and second arms taper from a maximum width at a front edge of the first and second arm back to the lever shaft.

According to an aspect is a pry bar tool comprising an elongated lever shaft; a first end of the pry bar tool, the first end defining a U-shaped or V-shaped engagement portion configured to engage and exert force on a body to be removed from a surface; a curved fulcrum positioned between the elongated lever shaft and the first end; and a padded forearm handle positioned at a second end of the pry bar tool, wherein the handle comprises a curved inner surface sized to receive a forearm and configured to receive a force exerted from said received forearm, and further wherein the forearm handle comprises a first curved arm extending outwardly from the lever shaft and a second curved arm extending outwardly from the lever shaft, wherein a top edge of the first and second arms are substantially perpendicular to the lever shaft, and further wherein a bottom edge of the first and second arms taper from a maximum width at a front edge of the first and second arm back to the lever shaft.

These and other aspects and embodiments of the invention will be described in greater detail below, and can be further derived from reference to the specification and figures.

### BRIEF DESCRIPTION OF THE DRAWINGS

The present invention will be more fully understood and appreciated by reading the following Detailed Description in conjunction with the accompanying drawings, in which:

FIG. 1 is a schematic representation of a side view of a pry bar device with a forearm receptacle, in accordance with an embodiment.

FIG. 2 is a schematic representation of a front view of a pry bar device with a forearm receptacle, in accordance with an embodiment.

FIG. 3 is a schematic representation of a side view of an elongated pry bar device with a forearm receptacle, in accordance with an embodiment.

FIG. 4 is a schematic representation of a cross-sectional view taken generally along line S-S in FIG. 2, in accordance with an embodiment.

FIG. 5 is a schematic representation of a side view of a pry bar device and a forearm attachment, in accordance with an embodiment.

FIG. 6 is a schematic representation of a reverse view and a side view of a forearm receptacle of an elongated pry bar device receptacle, in accordance with an embodiment.

FIG. 7A is a schematic representation of a reverse view of a forearm attachment, in accordance with an embodiment.

FIG. 7B is a schematic representation of a reverse side view of a forearm attachment, in accordance with an embodiment.

### DETAILED DESCRIPTION OF EMBODIMENTS

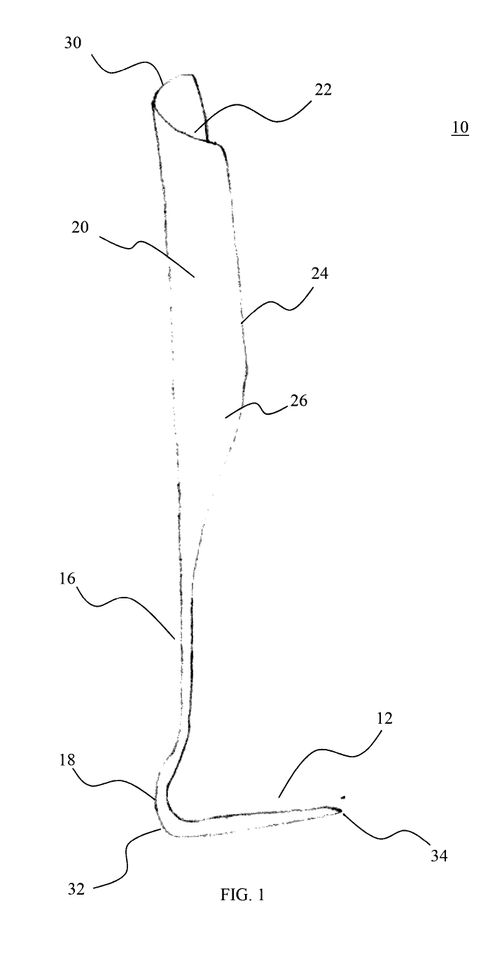

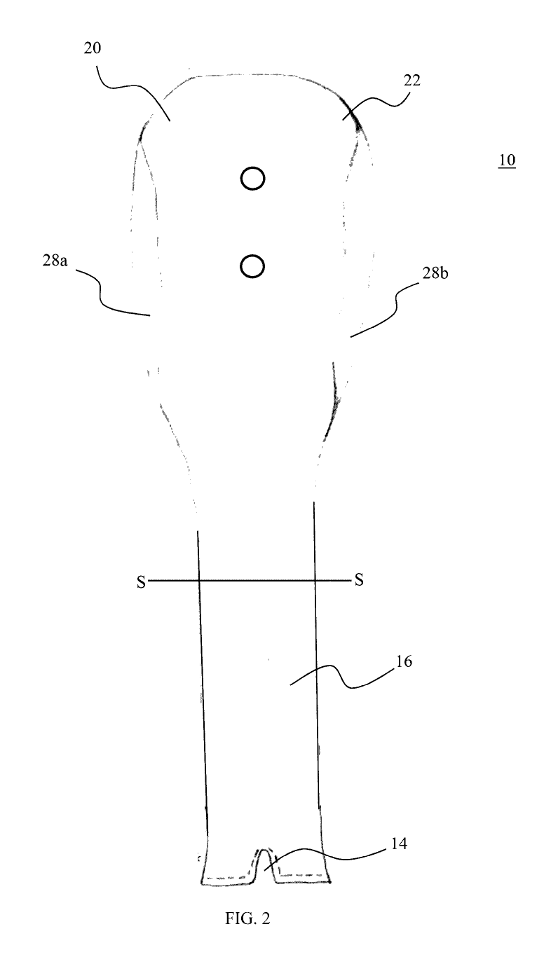

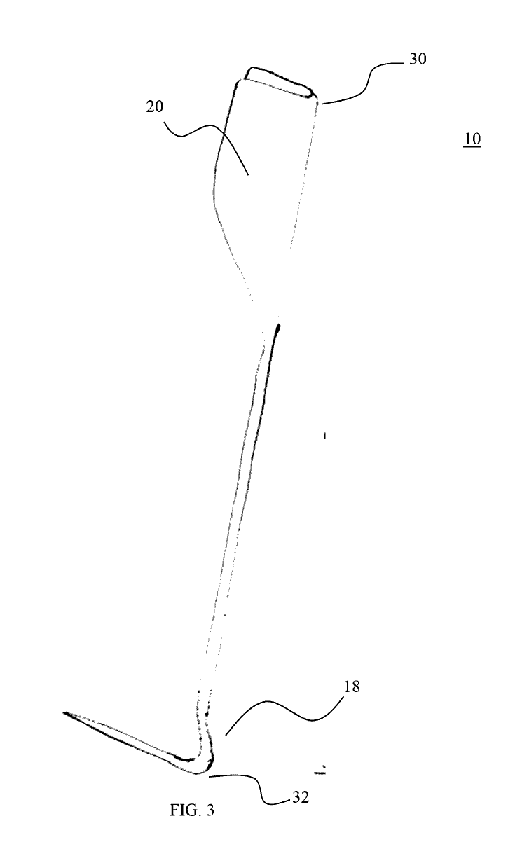

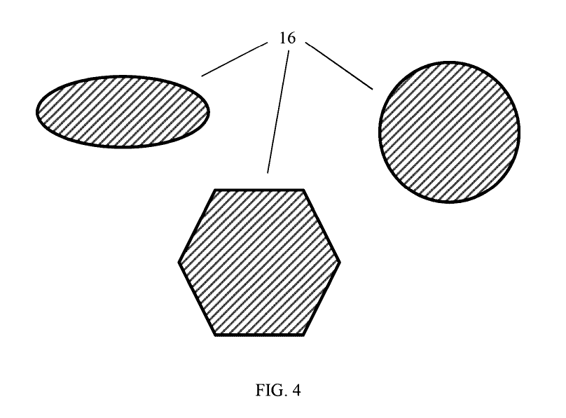

Referring now to the drawings, wherein like reference numerals refer to like parts throughout, there is seen in FIG. 1 a pry bar device 10. According to an embodiment, pry bar device 10 includes an end 12 which can be broadened or flattened and can contain a U-shaped or V-shaped indentation 14, as shown in FIG. 2, into which a nail or similar structure to be pried can be placed. Pry bar device 10 also includes a lever shaft 16 which can be substantially flat, rounded, or a combination of shapes, diameters, and sizes. As shown in FIG. 4, for example, lever shaft 16 may have a cross-section of any of a variety of shapes, including oval, round, hexagonal, rectangular, and triangular, among many other shapes. As described in greater detail below, the user can grasp the lever shaft with one or more hands during use. Accordingly, the lever shaft can be textured or otherwise structured or designed to improve the user's grip. Pry bar device 10 includes a bend 18 positioned between end 12 and lever shaft 16. The bend operates as the fulcrum point to transfer force from lever shaft 16 upon which the user exerts force and end 12 which exerts that force on the nail or similar structure wedged into the U-shaped or V-shaped indentation 14. In order to allow the nail or similar structure to be wedged into the U-shaped or V-shaped indentation, for example, end 12 is broadened or flattened, as shown in FIGS. 1 and 3.

Referring again to FIG. 1, pry bar device 10 includes a handle 20 which comprises a curved or U-shaped receptacle configured to substantially receive at least a portion of the user's forearm. During use, the user inserts their forearm into the inner portion 22 of the curved or U-shaped receptacle of handle 20, and then optionally grasps the lever shaft 16 with the hand of that forearm, thereby holding the forearm in place, as well as properly positioning the pry bar device. The user can then exert a force with both their hand and their forearm on the device, and that force is transferred via the fulcrum to end 12 for prying or pulling.

According to an embodiment, pry bar device 10 is constructed of a steel or steel alloy, such as a high-carbon steel. In addition, any material or combination of materials with sufficiently high strength and durability can be utilized to construct pry bar 10.

Referring to FIG. 2 is a front view of pry bar device 10 including inner portion 22 of handle 20. Handle 20, including inner portion 22, can be sized or shaped to fit a wide variety of forearms, or it can be specifically tailored to an individual or small range of individuals such as men, women, children, or other size and/or shape ranges. According to an embodiment, handle 20 is substantially formed in whole or in part by two spaced arms or wings 28a and 28b that extend from the lever shaft 16. The wings or arms can be integral to the pry bar, or can be attached to the pry bar. As shown in FIG. 1, for example, the wings or arms can extend out to a maximum point 24, and then can gradually taper back to the lever shaft 16 along a tapering line 26. Alternatively, the wings or arms can be more rectangular in shape and have a more angular profile instead of a gradual taper back to the lever shaft 16. Arms 28a and 28b can also taper at the top of the lever shaft 16.

According to an embodiment, the entire length of pry bar device 10 from the tip of end 12 to the tip of handle 20 is a standard length for an average pry bar or crowbar. For example, according to one embodiment, the pry bar is approximately 15 inches from the tip 30 of handle 20 to the fulcrum point 32 of fulcrum 18, although many other lengths are possible. The length of pry bar device 10 from the fulcrum point 18 to the tip 34 of the end 12 can be approximately 3 inches, although many other lengths are possible. Referring now to FIG. 3, for example, is an elongated pry bar device 10. The pry bar is approximately 4 feet (48 inches) from the tip 30 of handle 20 to the fulcrum point 32 of fulcrum 18, although many other lengths are possible.

According to an embodiment, handle 20 of pry bar device 10 can include an insert, coating, padding, or other structure (not shown) to cushion the forearm and/or to prevent slippage during use. The coating or insert provides comfort to the user while maximizing the amount of force the user can exert on the handle and lever shaft. The coating or insert can be permanently or removably attached to the handle. For example, a coating may be applied by spraying, gluing, or otherwise applying a polymer or other compound to the inner surface 22 of the handle 20, and then actively drying or allowing the compound to dry. The compound can include, for example, a non-slipping agent such as sand, grit, or other gripping compound that allows the user to exert more force without worrying about their forearm slipping around within, or out of, the handle. As another example, an insert can be permanently attached to the inner surface 22 of the handle 20, which can provide comfort and/or prevent slippage. To provide comfort, the insert can be a padding such as cloth, cushioning, polymer, gel, or other padding or cushioning substance or material. The insert can be glued, stapled, screwed, or otherwise permanently attached to the inner surface 22. According to yet another embodiment, the insert is removably attached to the inner surface 22 of handle 20. In this embodiment, the insert can again be a padding such as cloth, cushioning, polymer, gel, or other padding or cushioning substance or material. This material is temporarily attached to the inner surface 22 by means of snaps, hooks, Velcro, or other temporary attachment means. This allows a variety of users to use or not use the insert depending on their personal preference.

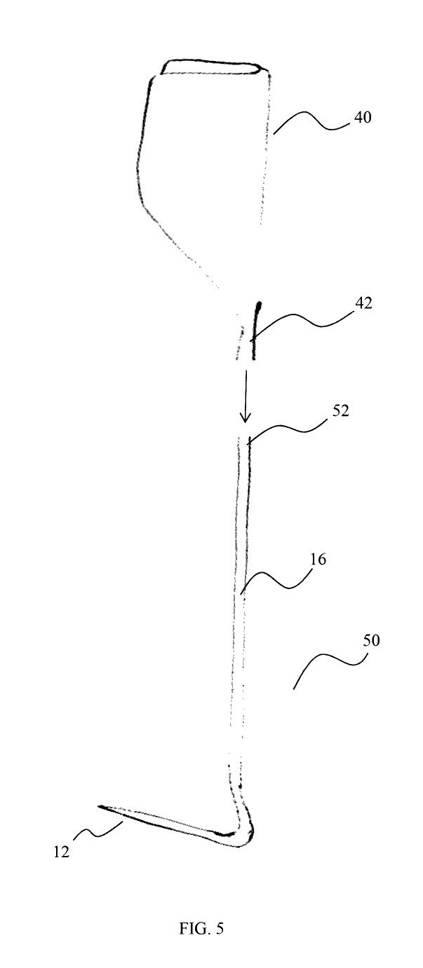

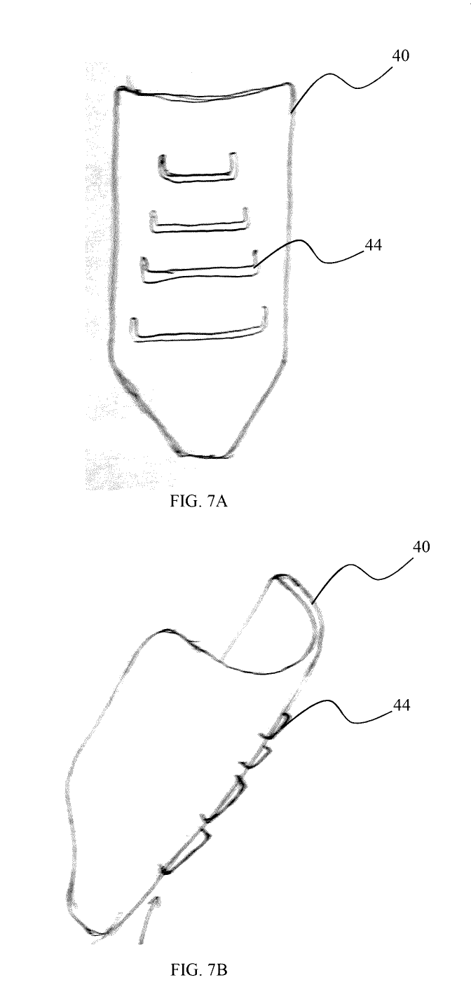

According to an embodiment, a pry bar device 50 receives—either permanently or reversibly—a forearm attachment 40, as shown for example in FIGS. 5 and 7. The pry bar device 50 can be any of the pry bar devices known in the art or described or otherwise envisioned herein. For example, pry bar device 50 can include an end 12 which can be broadened or flattened and can contain a U-shaped or V-shaped indentation. The pry bar device can include a lever shaft 16 which can be substantially flat, rounded, or a combination of shapes, diameters, and sizes. The pry bar device can also include an end 52 of lever shaft 16 that receives the forearm attachment. As shown in FIG. 5, for example, the forearm attachment 40 can include a hollowed portion 42 which fits over or onto a portion of end 52 of lever shaft 16. According to another embodiment, the forearm attachment 40 is wrapped around lever shaft 16. Alternatively, it can be snapped, glued, pinned, nailed, or screwed into place on lever shaft 16. Once the forearm attachment 40 is properly positioned, according to a preferred embodiment it is then fastened, attached, or otherwise substantially affixed in order to prevent movement of the attachment during use. Affixing can mean reversibly or permanently attaching.

According to another embodiment as shown in FIGS. 7A and 7B, for example, the forearm attachment 40 includes one or more slots 44 to provide an opening on the back side of the attachment that allows the pry bar device 50 to pass through one or more of the slots which then grip the pry bar device to result in a single piece. The slots 44 can be formed in the body of the forearm attachment, or can be formed by extensions that extend outwardly from the body of the attachment, among other configurations.

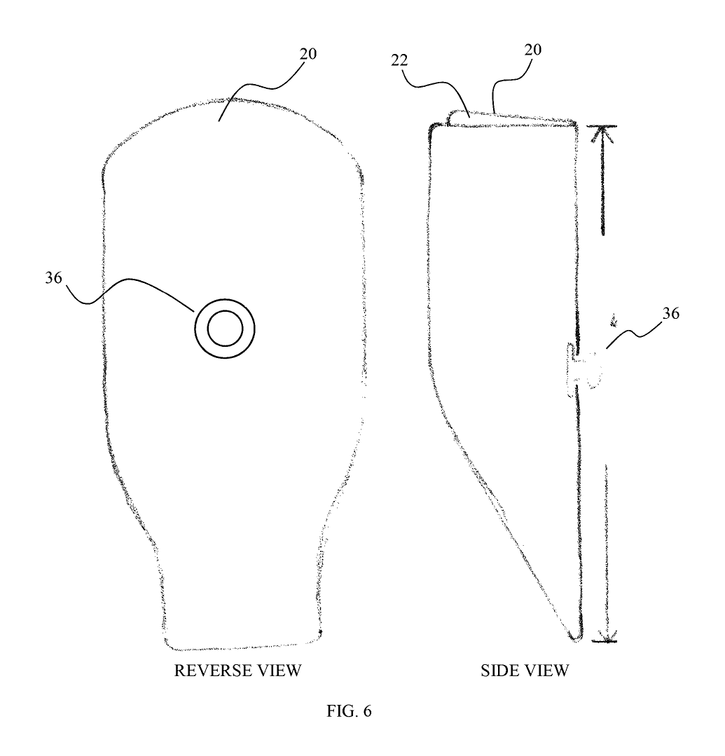

Referring now to FIG. 6, handle 20 (or forearm attachment 40) can include one or more features that improve functionality of the pry bar device 10 in general. For example, as shown in FIG. 6, the handle 20 includes a spindle 36 that extends outwardly from the reverse side of the handle 20. Here, reverse means the side of the handle opposite the inner portion 22, as shown in FIG. 6. The spindle 36 is an extension that allows the pry bar to be temporarily and conveniently affixed to another object such as a belt or wall. For example, the spindle can be used to hang the pry bar for sale. Alternatively, the user can have a belt, such as a utility belt, to which the spindle can hook, insert, or otherwise attach.

According to an embodiment, to use a pry bar device 10, which is either the single component device or the assembled device, the user grasps the device at a point along lever shaft 16 with their dominant hand in order to properly position the device. The user then positions their forearm comfortably within the inner portion 22 of the handle 20. Continuing to hold the lever shaft 16, the user can exert a force with their entire body along the length of their forearm to inner portion 22 of the handle 20. This force is transferred via the fulcrum to the U-shaped or V-shaped indentation 14 of end 12, which exerts a prying or pulling force on the nail or similar object in the surface.

Although the present invention has been described in connection with a preferred embodiment, it should be understood that modifications, alterations, and additions can be made to the invention without departing from the scope of the invention as defined by the claims.

What is claimed is:

1. A pry bar tool comprising:
a lever shaft;
a first end, the first end defining a U-shaped or V-shaped engagement portion configured to engage and exert force on a body to be removed from a surface;
a curved fulcrum positioned between the elongated lever shaft and the first end; and
forearm handle positioned at a second end, wherein the handle comprises a curved inner surface sized to receive a forearm and configured to receive a force exerted from said received forearm.

2. The pry bar tool of claim 1, wherein the forearm handle is reversibly attachable.

3. The pry bar tool of claim 1, wherein at least a portion of the lever shaft is textured.

4. The pry bar tool of claim 1, wherein the forearm handle comprises a first curved arm extending outwardly from the lever shaft and a second curved arm extending outwardly from the lever shaft.

5. The pry bar tool of claim 4, wherein a top edge of the first and second arms are substantially perpendicular to the lever shaft, and further wherein a bottom edge of the first and second arms taper from a maximum width at a front edge of the first and second arm back to the lever shaft.

6. The pry bar tool of claim 1, wherein the forearm handle comprises a padding material.

7. The pry bar tool of claim 1, wherein the forearm handle comprises a non-slipping agent.

8. The pry bar tool of claim 1, wherein the forearm handle comprises a plurality of slots.

9. The pry bar tool of claim 1, wherein the forearm handle comprises spindle extending outwardly from a back surface of the forearm handle.

10. The pry bar tool of claim 1, wherein the forearm handle is sized to receive the forearm of an adult.

11. A pry bar tool comprising:
a lever shaft;
a first end, the first end defining a U-shaped or V-shaped engagement portion configured to engage and exert force on a body to be removed from a surface;
a curved fulcrum positioned between the elongated lever shaft and the first end; and
a forearm handle positioned at a second end, wherein the handle comprises a curved inner surface sized to receive a forearm and configured to receive a force exerted from said received forearm, and further wherein the forearm handle comprises a first curved arm extending outwardly from the lever shaft and a second curved arm extending outwardly from the lever shaft, wherein a top edge of the first and second arms are substantially perpendicular to the lever shaft, and further wherein a bottom edge of the first and second arms taper from a maximum width at a front edge of the first and second arm back to the lever shaft.

12. The pry bar tool of claim 11, wherein the forearm handle is reversibly attachable.

13. The pry bar tool of claim 11, wherein at least a portion of the lever shaft is textured.

14. The pry bar tool of claim 11, wherein the forearm handle comprises a padding material.

15. The pry bar tool of claim 11, wherein the forearm handle comprises a non-slipping agent.

16. The pry bar tool of claim 11, wherein the forearm handle comprises a plurality of slots.

17. The pry bar tool of claim 11, wherein the forearm handle comprises spindle extending outwardly from a back surface of the forearm handle.

18. A pry bar tool comprising:
An elongated lever shaft;
a first end of the pry bar tool, the first end defining a U-shaped or V-shaped engagement portion configured to engage and exert force on a body to be removed from a surface;
a curved fulcrum positioned between the elongated lever shaft and the first end; and
a padded forearm handle positioned at a second end of the pry bar tool, wherein the handle comprises a curved inner surface sized to receive a forearm and configured to receive a force exerted from said received forearm, and further wherein the forearm handle comprises a first curved arm extending outwardly from the lever shaft and a second curved arm extending outwardly from the lever shaft, wherein a top edge of the first and second arms are substantially perpendicular to the lever shaft, and further wherein a bottom edge of the first and second arms taper from a maximum width at a front edge of the first and second arm back to the lever shaft.

19. The pry bar tool of claim 18, wherein the forearm handle comprises a plurality of slots.

20. The pry bar tool of claim 18, wherein the forearm handle comprises spindle extending outwardly from a back surface of the forearm handle.
